(19) United States
(12) Patent Application Publication
(10) Pub. No.: US 2026/0100780 A1
(43) Pub. Date: Apr. 9, 2026

(54) SYSTEM AND METHOD FOR ENCODING, DECODING, AND TRANSMITTING PHYSICAL LAYER DATA

(71) Applicant: Norel Systems Limited, Tianjin (CN)

(72) Inventors: Yuanlong WANG, Tianjin (CN); Ke Liang, Tianjin (CN)

(21) Appl. No.: 19/417,551

(22) Filed: Dec. 12, 2025

Related U.S. Application Data
(63) Continuation of application No. PCT/CN2024/095153, filed on May 24, 2024.

(30) Foreign Application Priority Data
Jun. 14, 2023 (CN) 202310702786.0

(51) Int. Cl. H04L 1/00

(52) U.S. Cl. CPC H04L 1/0071; H04L 1/0041

(57) ABSTRACT

Disclosed in the present invention is a system and method for encoding, decoding, and transmitting physical layer data. Data is encoded with error-correcting codes. The data encoded by the error-correcting codes is interleaved at a granularity of 1 bit, with an interleaving depth of n. The interleaved data is then encoded with line codes, where the line code encoding is performed in groups of m-bit binary numbers. For data decoding, the received data is first decoded with line codes, and the data after line code decoding is in groups of m-bit binary numbers. This decoded data is then deinterleaved at a granularity of 1 bit, with a deinterleaving depth of n. Finally, the deinterleaved data is decoded with error-correcting codes. Both n and m are fixed positive integers, and n≥m.

### CROSS-REFERENCE TO RELATED APPLICATION

This application is a continuation application of International Patent Application No. PCT/CN2024/095153, filed on May 24, 2024, which itself claims priority to and benefit of Chinese Patent Application No. 202310702786.0 filed on Jun. 14, 2023 in the State Intellectual Property Office of P. R. China. The disclosure of each of the above applications is incorporated herein by reference in its entirety.

### TECHNICAL FIELD

The present invention relates to the field of communication technologies, and specifically to a system and method for encoding, decoding, and transmitting physical layer data.

### BACKGROUND ART

In a vehicle-mounted audio transmission system, due to the possible presence of noise interference in the in-vehicle environment, it is necessary to encode signals with error-correcting codes to improve the error-correcting capability and anti-interference capability of the system. The error-correcting codes are usually block codes, such as RS codes, ECC codes, or BCH codes. Generally, for a certain type of error-correcting code, its error-correcting capability is positively correlated with the number of redundant bits added. The stronger the error-correcting capability, the more redundant bits are needed. For example, a certain type of error-correcting code that can correct at most one bit of error has fewer redundant bits than the same type of error-correcting code that can correct at most two bits of errors. Fewer redundant bits can increase the proportion of effective data bits in the transmitted data, thereby improving transmission efficiency.

When the interference is burst errors, to further improve the error-correcting capability, interleaving can be used to distribute the burst errors into different block codes, converting long burst errors into short burst errors. This ensures that the number of error data bits in each group of block codes remains within the error-correcting capability, thereby improving the system's ability to resist burst errors. The international standard ISO7637-2 (International Organization for Standardization7637-2) tests the situation where vehicle-mounted transmission lines are subject to fast short-pulse interference. The interference time of each fast short pulse on the signal on the transmission line can reach 50 ns. For a common vehicle-mounted audio transmission line with a transmission rate of 100 Mbps, this can cause up to 5 consecutive bit errors.

To facilitate the recovery of clock and data at the receiving end, line codes can be used to encode the transmitted data to ensure sufficient transitions between “0” and “1” in the data. Common line codes include 4b/5b codes, 8b/10b codes, 9b/10b codes, etc. Among them, 8b/10b codes and 9b/10b codes can make the number of “0”s and “1”s equal in the encoded data stream, achieving the purpose of eliminating the DC component of the signal during data transmission. Therefore, such codes represented by 8b/10b codes and 9b/10b codes are also called DC-balanced codes. After encoding with line codes, a 1-bit error on the transmission channel can be expanded into a 1-symbol error after line code decoding. For example, a 1-bit error in the signal encoded by the 8b/10b DC-balanced code on the transmission channel is expanded into an 8-bit (1-byte) error after decoding. If the length of the burst error occurring on the transmission channel is greater than 1 bit but not greater than the length of the encoded symbol+1 (for the 8b/10b DC-balanced code, the length of one encoded symbol is 10 bits), taking a continuous 2-bit error length as an example, when these 2 bits belong to 2 symbols after decoding, the continuous 2-bit error is expanded into a 2-symbol error after decoding. For example, a continuous 2-bit error in the signal encoded by the 8b/10b DC-balanced code on the transmission channel can be expanded into a maximum of 16-bit errors in 2 bytes after decoding. If the length of the burst error occurring on the transmission channel is greater than the length of one encoded symbol+1, the burst error may be expanded into an error of 3 or more symbols after decoding.

In the test of the international standard ISO7637-2, the interference time of each fast short pulse on the signal on the transmission line can reach 50 ns. Taking a data transmission rate of 100 Mbps as an example, 5 consecutive bit errors will occur on the transmission channel. When these 5 bits belong to 2 symbols after decoding, the 5-bit burst error is expanded into a 2-symbol error after decoding.

In a vehicle-mounted audio transmission system, the transmission link may include multiple nodes/chips, and each node/chip is connected to its respective processor/microphone/power amplifier and other modules/devices. For example, node A is connected to node B, and node B is connected to node C. When node A has data to send to node C, it can first send the data to node B, and then node B sends the data to node C. Node B can also receive data from the devices connected to it and send the data to node C. Node A is the upstream node of node B, node B is the upstream node of node C, node B is the downstream node of node A, and node C is the downstream node of node B. Node A can encapsulate the data to be sent to node C into data blocks and send the data blocks to node B. After receiving the data blocks from node A, node B can choose to preset replacement of the data blocks with the data from the devices connected to it and send the data blocks after data replacement to node C.

In the current vehicle-mounted audio transmission systems, there is a lack of a method that can not only resist burst errors and use line codes to realize clock and data recovery but also realize data replacement with low delay.

### SUMMARY

The technical problem to be solved by the present invention is how to not only resist burst errors but also realize data replacement with low delay when using line codes to realize clock and data recovery in a vehicle-mounted audio transmission system.

To solve the above-mentioned technical problem, the technical solution adopted by the present invention is as follows:

As a physical layer data encoding, decoding, and transmission system of the present invention, it comprises a first transmission terminal, a second transmission terminal, and a transmission channel. The first transmission terminal sends data to the second transmission terminal through the transmission channel. The first transmission terminal comprises an error-correcting code encoder, an interleaver, a line code encoder, and a transmitter. The second transmission terminal comprises a receiver, a line code decoder, a deinterleaver, and an error-correcting code decoder. The error-correcting code encoder encodes data with error-correcting codes. The interleaver interleaves the data encoded by the error-correcting codes at a granularity of 1 bit, with an interleaving depth of n. The line code encoder encodes the interleaved data with line codes, and the line code encoding is performed in groups of m-bit binary numbers. The transmitter sends the data encoded by the line codes to the transmission channel, and the data is transmitted to the second transmission terminal through the transmission channel. The receiver receives the data sent through the transmission channel. The line code decoder decodes the received data with line codes, and the data after line code decoding is in groups of m-bit binary numbers. The deinterleaver deinterleaves the data decoded by the line codes at a granularity of 1 bit, with a deinterleaving depth of n. The error-correcting code decoder decodes the deinterleaved data with error-correcting codes. Both n and m are fixed positive integers, and n≥m.

Preferably, the line code is a DC-balanced code.

Preferably, n≥2 m.

Preferably, the error-correcting code is a block code.

Further, each group of the block codes can correct at most one bit of error.

Preferably, the error-correcting code is an RS code, an ECC code, or a BCH code.

As a physical layer data encoding method of the present invention, data is encoded with error-correcting codes, the data encoded by the error-correcting codes is interleaved at a granularity of 1 bit with an interleaving depth of n, and the interleaved data is encoded with line codes in groups of m-bit binary numbers. Both n and m are fixed positive integers, and n≥m.

Preferably, the line code is a DC-balanced code.

Preferably, n≥2 m.

Preferably, the error-correcting code is a block code.

Further, each group of the block codes can correct at most one bit of error.

Preferably, the error-correcting code is an RS code, an ECC code, or a BCH code.

As a physical layer data decoding method of the present invention, received data is decoded with line codes, and the data after line code decoding is in groups of m-bit binary numbers. The data decoded by the line codes is deinterleaved at a granularity of 1 bit with a deinterleaving depth of n, and the deinterleaved data is decoded with error-correcting codes. Both n and m are fixed positive integers, and n≥m.

Preferably, the line code is a DC-balanced code.

Preferably, n≥2 m.

Preferably, the error-correcting code is a block code.

Further, each group of the block codes can correct at most one bit of error.

Preferably, the error-correcting code is an RS code, an ECC code, or a BCH code.

As a physical layer data replacement method of the present invention, it is used for transmitting data blocks through a transmission system. The transmission system comprises a first transmission terminal, a second transmission terminal, and a transmission channel. The first transmission terminal is connected to the second transmission terminal through the transmission channel. The first transmission terminal encodes the data blocks with error-correcting codes to generate data blocks encoded by the error-correcting codes, interleaves the encoded data blocks at a granularity of 1 bit with an interleaving depth of n, then encodes the interleaved data with line codes in groups of m-bit binary numbers, and finally sends the symbols generated after line code encoding to the transmission channel. The second transmission terminal receives and decodes the symbols encoded by the line codes sent through the transmission channel, replaces the data at the preset replacement positions in the data decoded by the line codes, and re-encodes the replaced data with line codes. Both n and m are fixed positive integers, and n≥m.

Preferably, the line code is a DC-balanced code.

Preferably, n≥2m.

Preferably, the error-correcting code is a block code.

Further, each group of the block codes can correct at most one bit of error.

Preferably, the error-correcting code is an RS code, an ECC code, or a BCH code.

The beneficial effects of the present invention are:

The system and method for encoding, decoding, and transmitting physical layer data of the present invention interleaves the data encoded by the error-correcting codes at a granularity of 1 bit with an interleaving depth of n, and encodes the interleaved data with line codes in groups of m-bit binary numbers, with n≥m. This method can not only resist burst errors but also realize data replacement with low delay when using line codes to realize clock and data recovery.

### BRIEF DESCRIPTION OF DRAWINGS

FIG. 1 is a block diagram of a physical layer data encoding, decoding, and transmission system of the present invention;

FIG. 2 is a schematic diagram of error-correcting code encoding in the physical layer data encoding, decoding, and transmission system of the present invention;

FIG. 3 is a schematic diagram of interleaving in the physical layer data encoding, decoding, and transmission system of the present invention;

FIG. 4 is a schematic diagram of a line code expanding a 1-bit error into an 8-bit error in the physical layer data encoding, decoding, and transmission system of the present invention;

FIG. 5 is a schematic diagram of deinterleaving data containing 8-bit errors after line code encoding in the physical layer data encoding, decoding, and transmission system of the present invention;

FIG. 6 is a schematic diagram of error-correcting code decoding for 8 groups of block codes each containing 1-bit error data in the physical layer data encoding, decoding, and transmission system of the present invention;

FIG. 7 is a schematic diagram of a line code expanding a 2-bit error into a 16-bit error in the physical layer data encoding, decoding, and transmission system of the present invention;

FIG. 8 is a schematic diagram of deinterleaving data containing 16-bit errors after line code encoding in the physical layer data encoding, decoding, and transmission system of the present invention;

FIG. 9 is a schematic diagram of error-correcting code decoding for 16 groups of block codes each containing 1-bit error data in the physical layer data encoding, decoding, and transmission system of the present invention;

FIG. 10 is a flowchart of a physical layer data encoding method of the present invention;

FIG. 11 is a flowchart of a physical layer data decoding method of the present invention;

FIG. 12 is a block diagram of a transmission system of a physical layer data replacement method of the present invention;

FIG. 13 is a flowchart of a method for a second transmission terminal to perform data block replacement in the transmission system of the physical layer data replacement method of the present invention;

FIG. 14 is a schematic diagram of a second transmission terminal performing data block replacement in the transmission system of the physical layer data replacement method of the present invention;

FIG. 15 is a schematic diagram of a second transmission terminal performing multiple data block replacements in the transmission system of the physical layer data replacement method of the present invention;

Wherein:
1. First transmission terminal;
2. Second transmission terminal;
3. Transmission channel;
11. Error-correcting code encoder;
12. Interleaver;
13. Line code encoder;
14. Transmitter;
21. Receiver;
22. Line code decoder;
23. Deinterleaver;
24. Error-correcting code decoder.

### DETAILED DESCRIPTION OF EMBODIMENTS

The technical solutions in the embodiments of the present invention will be clearly and completely described below in conjunction with the drawings. It can be understood that the described embodiments are only a part of the embodiments of the present invention, not all of them. Based on the embodiments of the present invention, all other embodiments obtained by those skilled in the art without making creative work shall fall within the protection scope of the present invention.

As shown in FIG. 1, in an application embodiment of the present invention, as a physical layer data encoding, decoding, and transmission system of the present invention, it comprises a first transmission terminal 1, a second transmission terminal 2, and a transmission channel 3. The first transmission terminal 1 sends data to the second transmission terminal 2 through the transmission channel 3. The first transmission terminal 1 comprises an error-correcting code encoder 11, an interleaver 12, a line code encoder 13, and a transmitter 14. The second transmission terminal 2 comprises a receiver 21, a line code decoder 22, a deinterleaver 23, and an error-correcting code decoder 24.

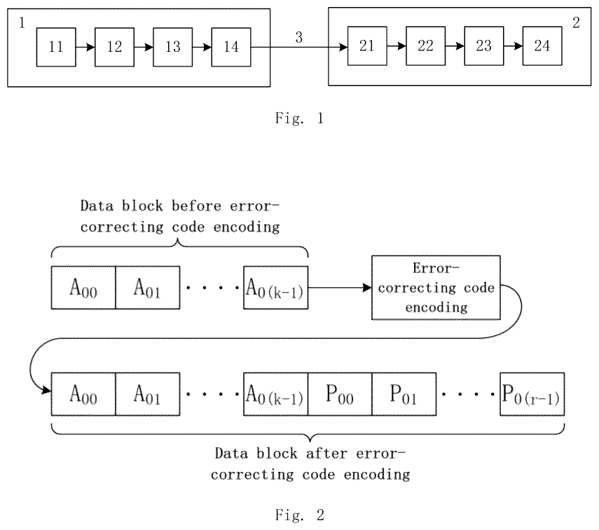

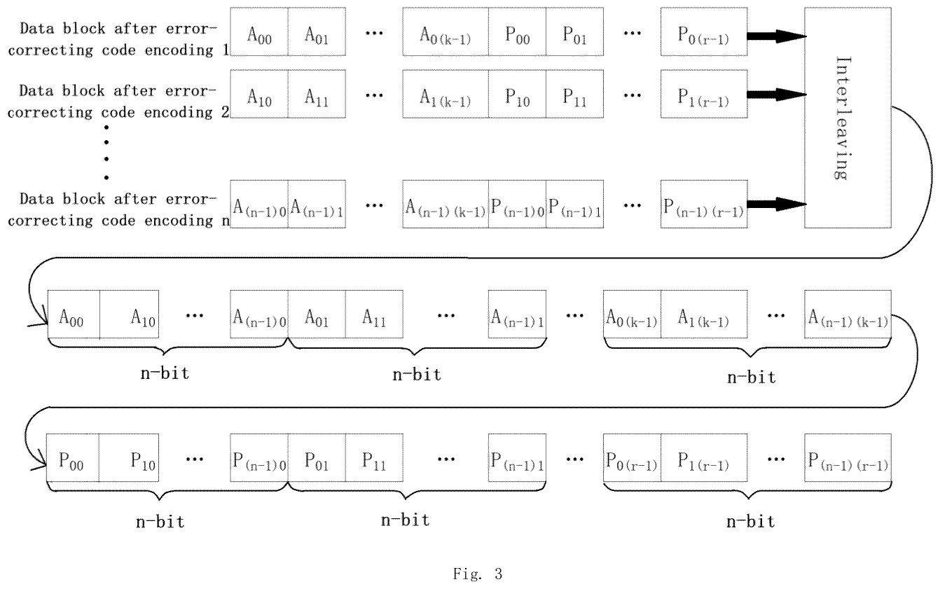

The error-correcting code encoder 11 encodes data with error-correcting codes to improve the error-correcting capability and anti-interference capability of the system. The error-correcting codes are block codes, which can be, but are not limited to, RS codes, BCH codes, or ECC codes. As shown in FIG. 2, A₀₀, A₀₁, . . . A_{0(K-1)} are k-bit binary data, which are used as data blocks before error-correcting code encoding and enter the error-correcting code encoder for error-correcting code encoding. After encoding, r-bit redundant binary data P₀₀, P₀₁, . . . P₀₍ᵣ₋₁₎ are added to the k-bit binary data to form data blocks encoded by the error-correcting codes. Therefore, after error-correcting code encoding, the k-bit binary data generates a total of k+r-bit binary data. Generally, for a certain type of error-correcting code, its error-correcting capability is positively correlated with the number of redundant bits added. The stronger the error-correcting capability, the more error bits it can correct, and the more redundant bits are needed. The weaker the error-correcting capability, the fewer error bits it can correct, and the fewer redundant bits are needed. For example, a certain type of error-correcting code that can correct at most one bit of error has fewer redundant bits than the same type of error-correcting code that can correct at most two bits of errors. Reducing the number of redundant bits r can increase the proportion of effective data bits in all transmitted data, thereby improving transmission efficiency. The present invention does not limit the number of bits that the error-correcting code can correct. In this embodiment, to improve transmission efficiency, an error-correcting code that can correct at most one bit of error data can be selected.

The interleaver 12 interleaves the data encoded by the error-correcting codes at a granularity of 1 bit, with an interleaving depth of n. When burst errors occur due to interference on the transmission channel 3, interleaving can be used to distribute the burst errors into different data blocks encoded by the error-correcting codes, converting long burst errors into short errors for each data block encoded by the error-correcting codes. This enables the use of error-correcting codes with weak error-correcting capability to correct long burst errors on the transmission channel 3. As shown in FIG. 3, n groups of data blocks encoded by the error-correcting codes (each group has a length of k+r bits) from 1 to n are interleaved at a granularity of 1 bit, and after interleaving, k+r groups of data are obtained, each group being continuous n-bit binary data.

The line code encoder 13 encodes the interleaved data with line codes. The data before line code encoding takes m bits as one pre-line-code-encoding symbol, and the line code encoding is performed in groups of one symbol (m-bit binary number) before line code encoding. Common line codes include 4b/5b codes, 8b/10b codes, 9b/10b codes, etc. At this time, the values of m are 4, 8, and 9 respectively, which are called the lengths of symbols before line code encoding. The corresponding lengths of symbols after line code encoding are 5, 10, and 10 respectively.

Encoding the transmitted data with line codes can ensure sufficient transitions between “0 ” and “1” in the data, facilitating the recovery of clock and data at the receiving end. Among them, 8b/10b codes and 9b/10b codes can make the number of “0”s and “1”s equal in the encoded data stream. Therefore, such codes represented by 8b/10b codes and 9b/10b codes are also called DC-balanced codes. DC-balanced codes can achieve the purpose of eliminating the DC component of the signal during data transmission, thereby reducing the design difficulty of the receiving circuit and the receiving bit error rate. The present invention can use 8b/10b codes and 9b/10b codes, and can also use other DC-balanced codes or other non-DC-balanced codes. The present invention does not limit the line codes used.

The transmitter 14 sends the data encoded by the line codes to the transmission channel 3, and the data is transmitted to the second transmission terminal through the transmission channel 3. The receiver 21 receives the data sent through the transmission channel 3. The line code decoder 22 decodes the received data with line codes, and the data after line code decoding is in groups of m-bit binary numbers (corresponding to one symbol before line code encoding).

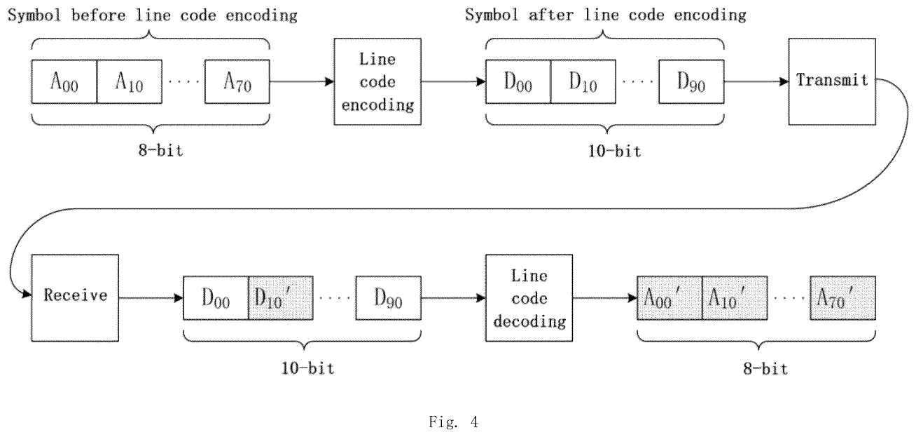

After encoding with line codes, a 1-bit error on the transmission channel 3 is expanded into a 1-symbol error after line code decoding. For example, a 1-bit error in the signal encoded by the 8b/10b DC-balanced code on the transmission channel 3 is expanded into an 8-bit (1-byte) error after decoding with the 8b/10b DC-balanced code. Taking m=8 as an example, as shown in FIG. 4, one symbol before line code encoding after interleaving contains bit data {A₀₀, A₁₀, A₂₀, A₃₀, A₄₀, A₅₀, A₆₀, A₇₀}. After line code encoding, symbol bit data {D₀₀, D₁₀, D₂₀, D₃₀, D₄₀, D₅₀, D₆₀, D₇₀, D₈₀, D₉₀} after line code encoding is obtained and sent to the transmission channel 3. Due to noise interference during data transmission, the received data has a certain bit error rate. The received data is D₀₀, D₁₀′, D₂₀, D₃₀, D₄₀, D₅₀, D₆₀, D₇₀, D₈₀, D₉₀, where D₁₀′ is different from D₁₀ and is error data. The received data containing error bits is decoded with line codes to obtain bit data {A₀₀′, A₁₀′, A₂₀′, A₃₀′, A₄₀′, A₅₀′, A₆₀′, A₇₀′}. Compared with {A₀₀, A₁₀, A₂₀, A₃₀, A₄₀, A₅₀, A₆₀, A₇₀} before line code encoding, there can be at most m bits different (m=8 in this example), that is, after line code decoding, there can be at most m bits of error data.

Other line codes, including but not limited to 4b/5b codes and 9b/10b codes, also have the situation where a 1-bit error on the transmission channel 3 is expanded into a 1-symbol error after line code decoding.

The deinterleaver 23 deinterleaves the data decoded by the line codes at a granularity of 1 bit, with a deinterleaving depth of n. After deinterleaving, n data blocks encoded by the error-correcting codes are generated, corresponding to the data blocks encoded by the error-correcting codes from 1 to n before interleaving as shown in FIG. 3. Although a 1-bit error on the transmission channel 3 can be expanded into a 1-symbol error after line code decoding, resulting in at most m bits of errors, after deinterleaving, these at most m bits of errors are distributed into the n data blocks encoded by the error-correcting codes generated by the deinterleaver 23. When n≥m, each data block encoded by the error-correcting codes generated by the deinterleaver 23 contains at most 1 bit of error. Thus, an error-correcting code with an error-correcting capability of 1 bit can be used to correct the 1-bit error on the transmission channel 3.

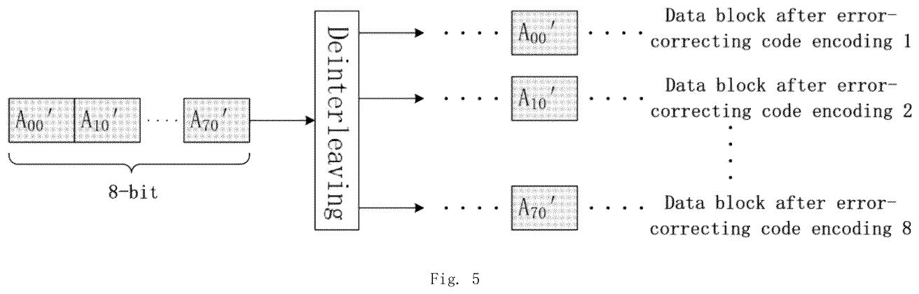

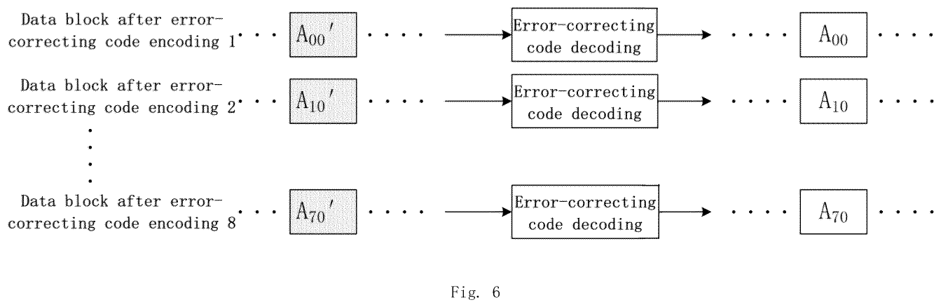

Taking n=8 and m=8 as an example, as shown in FIG. 5, the possible 8-bit error data {A₀₀′, A₁₀′, A₂₀′, A₃₀′, A₄₀′, A₅₀′, A₆₀′, A₇₀′} decoded by the line codes is deinterleaved. After deinterleaving, 8 data blocks encoded by the error-correcting codes from 1 to 8 are obtained, and each data block encoded by the error-correcting codes contains at most 1 bit of error data.

The error-correcting code decoder 24 decodes the deinterleaved data with error-correcting codes. As shown in FIG. 6, the 8 data blocks encoded by the error-correcting codes are decoded with error-correcting codes respectively. Each data block encoded by the error-correcting codes only needs to correct 1 bit of error data, and correct data can be obtained after decoding.

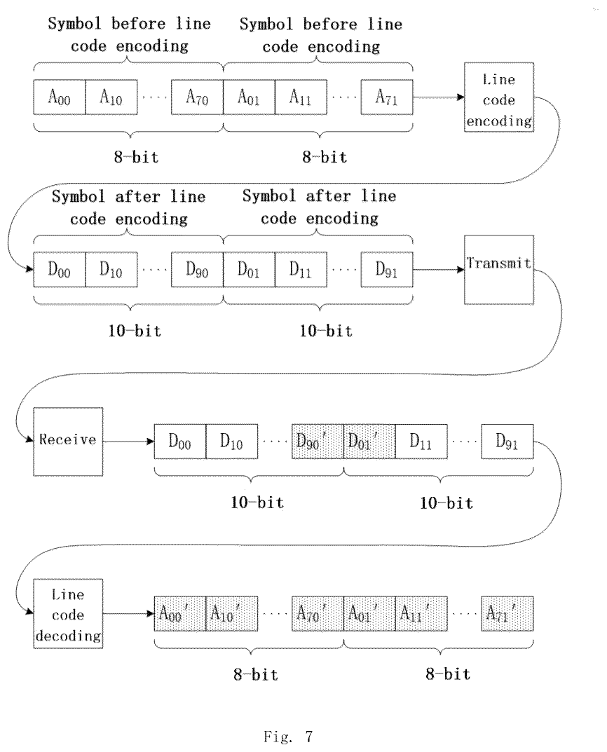

If the length of the burst error occurring on the transmission channel 3 is greater than 1 bit but less than or equal to the length of the symbol after line code encoding+1 (for example, for the 8b/10b DC-balanced code, the length of the symbol after line code encoding is 10 bits, and the length of the burst error occurring on the transmission channel 3 is greater than 1 bit but less than or equal to 11 bits), this burst error causes at most two symbol errors. Taking an error length of continuous 2 bits as an example, when these 2 bits of error data belong to 2 symbols after decoding, after line code decoding, the continuous 2-bit error can be expanded into at most 2-symbol errors. For example, a continuous 2-bit error in the signal encoded by the 8b/10b DC-balanced code on the transmission channel 3 is expanded into at most 2-byte (16-bit) errors after decoding with the DC-balanced code. Taking m=8 as an example, as shown in FIG. 7, two symbols before line code encoding after interleaving contain bit data {A₀₀, A₁₀, A₂₀, A₃₀, A₄₀, A₅₀, A₆₀, A₇₀} and {A₀₁, A₁₁, A₂₁, A₃₁, A₄₁, A₅₁, A₆₁, A₇₁} respectively. After line code encoding, two symbols after line code encoding are obtained, which contain bit data {D₀₀, D₁₀, D₂₀, D₃₀, D₄₀, D₅₀, D₆₀, D₇₀, D₈₀, D₉₀} and {D₀₁, D₁₁, D₂₁, D₃₁, D₄₁, D₅₁, D₆₁, D₇₁, D₈₁, D₉₁} respectively, and are sent to the transmission channel 3. Due to burst errors, the received data is bit data {D₀₀, D₁₀, D₂₀, D₃₀, D₄₀, D₅₀, D₆₀, D₇₀, D₈₀, D₉₀′} and {D₀₁′, D₁₁, D₂₁, D₃₁, D₄₁, D₅₁, D₆₁, D₇₁, D₈₁, D₉₁}, where D₉₀′ and D₀₁′ are different from D₉₀ and D₀₁ and are error data. The received bit data containing error bits is decoded with line codes to obtain bit data {A₀₀′, A₁₀′, A₂₀′, A₃₀′, A₄₀′, A₅₀′, A₆₀′, A₇₀′} and {A₀₁′, A₁₁′, A₂₁′, A₃₁′, A₄₁′, A₅₁′, A₆₁′, A₇₁′}. Compared with {A₀₀, A₁₀, A₂₀, A₃₀, A₄₀, A₅₀, A₆₀, A₇₀} before line code encoding, {A₀₀′, A₁₀′, A₂₀′, A₃₀′, A₄₀′, A₅₀′, A₆₀′, A₇₀′} can have at most m bits different. Compared with {A₀₁, A₁₁, A₂₁, A₃₁, A₄₁, A₅₁, A₆₁, A₇₁} before line code encoding, {A₀₁′, A₁₁′, A₂₁′, A₃₁′, A₄₁′, A₅₁′, A₆₁′, A₇₁′} can also have at most m bits different (m=8 in this example). Therefore, a continuous 2-bit error on the transmission channel 3 can cause at most 2 m (2 m=16 in this example) bits of error data after line code decoding. When the length of the burst error on the transmission channel 3 is greater than 1 bit but less than or equal to the length of the symbol after line code encoding+1, at most two symbols after line code encoding are affected. That is, as in the above example of continuous 2-bit errors, at most 2 m bits of error data are caused after line code decoding.

The deinterleaver 23 deinterleaves the data decoded by the line codes at a granularity of 1 bit, with a deinterleaving depth of n. After deinterleaving, n data blocks encoded by the error-correcting codes are generated, corresponding to the data blocks encoded by the error-correcting codes from 1 to n before interleaving as shown in FIG. 3. When the length of the burst error on the transmission channel 3 is greater than 1 bit but less than or equal to the length of the symbol after line code encoding+1, although the line code decoding can expand to 2 symbols, resulting in at most 2 m bits of errors, after deinterleaving, these at most 2 m bits of errors are distributed into the n data blocks encoded by the error-correcting codes generated by the deinterleaver 23. When n≥2 m, each data block encoded by the error-correcting codes generated by the deinterleaver 23 contains at most 1 bit of error. Thus, an error-correcting code with an error-correcting capability of 1 bit can be used to correct the burst errors on the transmission channel 3 whose length is greater than 1 bit but less than or equal to the length of the symbol after line code encoding+1.

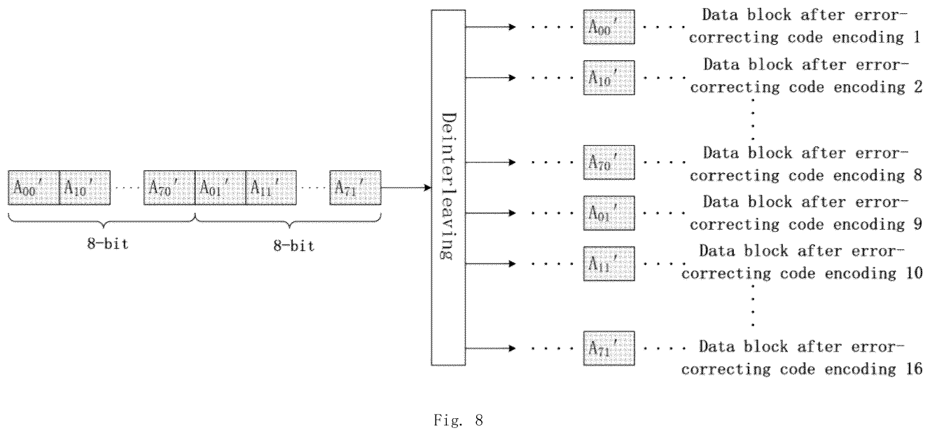

Taking n=16 and m=8 as an example, as shown in FIG. 8, the 16-bit error data A₀₀′, A₁₀′, A₂₀′, A₃₀′, A₄₀′, A₅₀′, A₆₀′, A₇₀′, A₀₁′, A₁₁′, A₂₁′, A₃₁′, A₄₁′, A₅₁′, A₆₁′, A₇₁′ decoded by the line codes is deinterleaved. After deinterleaving, 16 data blocks encoded by the error-correcting codes from 1 to 16 are obtained, and each data block encoded by the error-correcting codes contains at most 1 bit of error data.

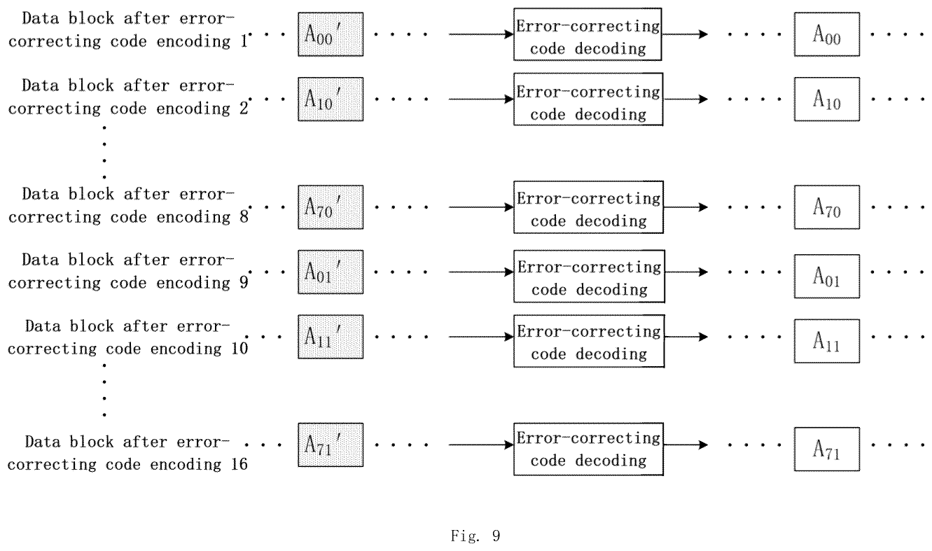

The error-correcting code decoder 24 decodes the deinterleaved data with error-correcting codes. As shown in FIG. 9, the 16 data blocks encoded by the error-correcting codes from 1 to 16 are decoded with error-correcting codes respectively. Each data block encoded by the error-correcting codes only needs to correct 1 bit of error data, and correct data can be obtained after decoding.

Therefore, when n≥2 m, the present invention can resist burst errors on the transmission channel 3 that are less than or equal to the length of the symbol after line code encoding+1. The international standard ISO7637-2 tests the situation where vehicle-mounted transmission lines are subject to fast short-pulse interference. The interference time of each fast short pulse on the signal on the transmission line can reach 50 ns. For a common vehicle-mounted audio transmission line with a transmission rate of 100 Mbps, this can cause up to 5 consecutive bit errors. By using common 4b/5b, 8b/10b, or 9b/10b line codes, the present invention can meet the test requirements of ISO7637-2 only by using an error-correcting code that can correct 1-bit errors.

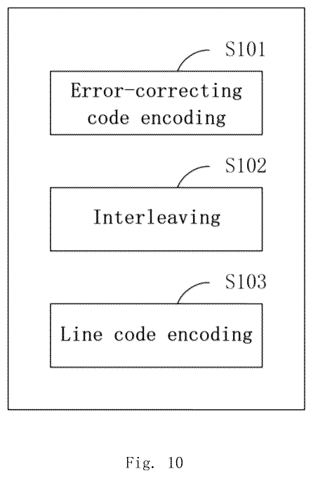

As shown in FIG. 10, in another application embodiment of the present invention, as a physical layer data encoding method of the present invention, it comprises the following steps: S101, encoding data with error-correcting codes; S102, interleaving the data encoded by the error-correcting codes at a granularity of 1 bit, with an interleaving depth of n; S103, encoding the interleaved data with line codes, and the line code encoding is performed in groups of m-bit binary numbers.

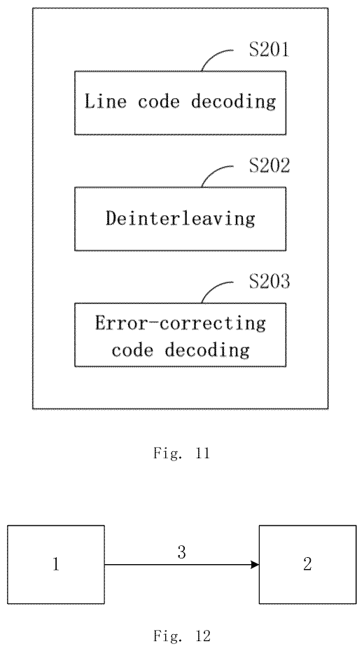

As shown in FIG. 11, in yet another application embodiment of the present invention, as a physical layer data decoding method of the present invention, it comprises the following steps: S201, decoding received data with line codes, and the data after line code decoding is in groups of m-bit binary numbers; S202, deinterleaving the data decoded by the line codes at a granularity of 1 bit, with a deinterleaving depth of n; S203, decoding the deinterleaved data with error-correcting codes.

In the embodiments shown in FIGS. 10 and 11, both n and m are fixed positive integers. The error-correcting codes are block codes, such as RS codes, ECC codes, or BCH codes. To improve transmission efficiency, n≥2 m can be set, so that an error-correcting code that can correct at most one bit of error can be selected to meet the test requirements of ISO7637-2.

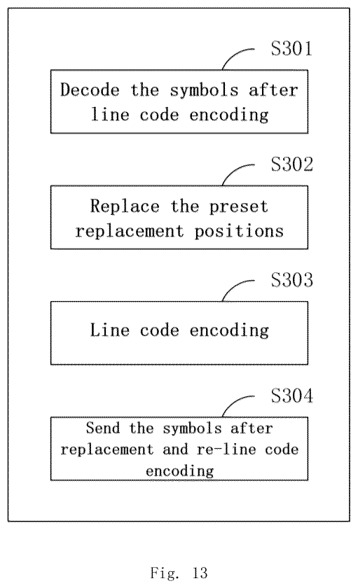

As shown in FIG. 12, in still another application embodiment of the present invention, as a physical layer data replacement method of the present invention, it is used for transmitting data blocks through a transmission system. The transmission system comprises a first transmission terminal 1, a second transmission terminal 2, and a transmission channel 3. In this embodiment, the first transmission terminal 1 sends data to the second transmission terminal 2 through the transmission channel 3. The second transmission terminal 2 receives the data from the first transmission terminal 1 and can also receive data from the modules/devices connected to it (the modules/devices connected to the second transmission terminal 2 are not shown in FIG. 12) to replace the data.

In this embodiment, the first transmission terminal 1 encodes the data blocks with error-correcting codes to generate data blocks encoded by the error-correcting codes, interleaves the encoded data blocks at a granularity of 1 bit with an interleaving depth of n, then encodes the interleaved data with line codes in groups of m-bit binary numbers, and finally sends the symbols generated after line code encoding to the transmission channel 3. The data blocks encoded by the error-correcting codes are generated by encoding the data blocks before error-correcting code encoding as shown in the embodiment in FIG. 2. The interleaving method is described in the embodiment in FIG. 3, and the line code encoding is described in the embodiment in FIG. 4.

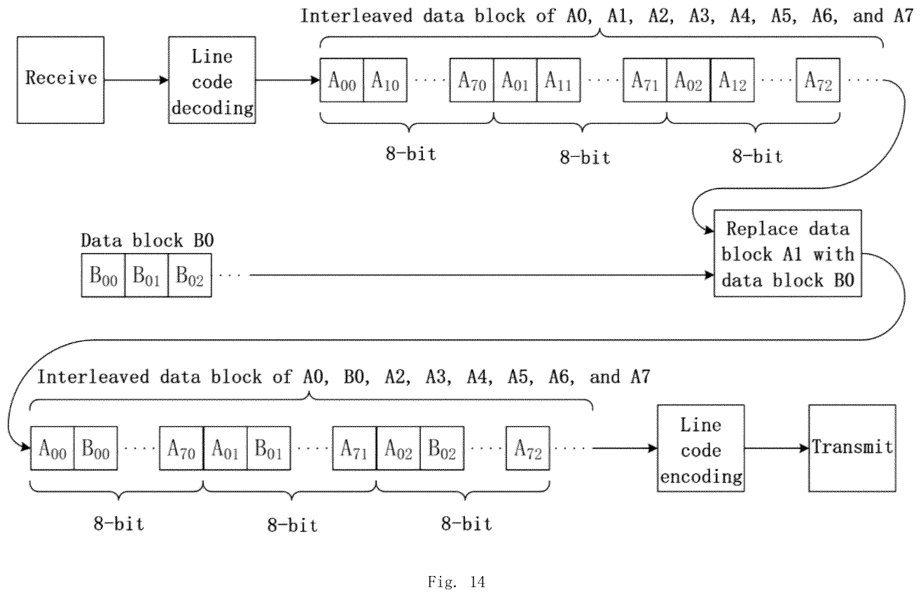

As shown in FIG. 13, in this embodiment, the method for the second transmission terminal 2 to perform data block replacement comprises the following steps: S301, the second transmission terminal 2 receives and decodes the symbols encoded by the line codes sent through the transmission channel 3; S302, the second transmission terminal 2 replaces the data at the preset replacement positions in the data decoded by the line codes; S303, the second transmission terminal re-encodes the replaced data with line codes; S304, the second transmission terminal sends the symbols after replacement and re-line code encoding.

As shown in FIG. 14, taking n=8 and m=8 as an example to further explain the method for the second transmission terminal to perform data block replacement as shown in FIG. 13. In this embodiment, the data received by the second transmission terminal 2 is the symbols encoded by the line codes, which are generated by interleaving and line code encoding the data blocks A0, A1, . . . by the first transmission terminal 1 and then sent to the transmission channel 3. The interleaver with an interleaving depth of n has n interleaving input channels from 1 to n. The data block encoded by the error-correcting codes transmitted on the interleaving input channel 1 is A0 (A0 is composed of bits A₀₀, A₀₁, A₀₂, . . . ) The data block encoded by the error-correcting codes transmitted on the interleaving input channel 2 is A1 (A1 is composed of bits A₁₀, A₁₁, A₁₂, . . .) . . . The data block encoded by the error-correcting codes transmitted on the interleaving input channel n is Aₙ₋₁ (Aₙ₋₁ is composed of bits A_{n-1,0}, A_{n-1,1}, A_{n-1,2}, . . .).

In this embodiment, the data blocks A0, A1, . . . are data blocks encoded by the error-correcting codes.

The second transmission terminal 2 decodes the symbols encoded by the line codes to generate the interleaved A0, A1, . . . and replaces the data block A1 with the data block B0 (B0 is composed of bits B₀₀, B₀₁, B₀₂, . . . ). As shown in FIG. 14, the first symbol generated by the decoding of the second transmission terminal 2 is {A₀₀, A₁₀, A₂₀, A₃₀, A₄₀, A₅₀, A₆₀, A₇₀}, and its 8 bits are respectively from the first bits of the data blocks A0, A1, . . . A7. The second transmission terminal 2 replaces the bit A₁₀ with the first bit B₀₀ of the data block B0, then re-encodes the data with line codes and sends it.

In this embodiment, the data block B0 is a data block encoded by the error-correcting codes. In the present invention, the second transmission terminal 2 can perform replacement after decoding the symbol encoded by the line codes that contains the preset replacement position (bit A₁₀). The delay of the replacement operation only comprises the decoding of one line code symbol, bit replacement, and line code encoding. In actual hardware implementation, the replacement operation can be completed in one clock cycle at the fastest, minimizing the replacement delay.

As shown in FIG. 14, the second symbol generated by the decoding of the second transmission terminal 2 is {A₀₁, A₁₁, A₂₁, A₃₁, A₄₁, A₅₁, A₆₁, A₇₁}, and its 8 bits are respectively from the second bits of the data blocks A0, A1, . . . A7. The second transmission terminal 2 replaces the bit A₁₁ with the second bit B₀₁ of the data block B0, then re-encodes the data with line codes and sends it.

The second transmission terminal 2 can replace other bits of the data block B0 according to the above description.

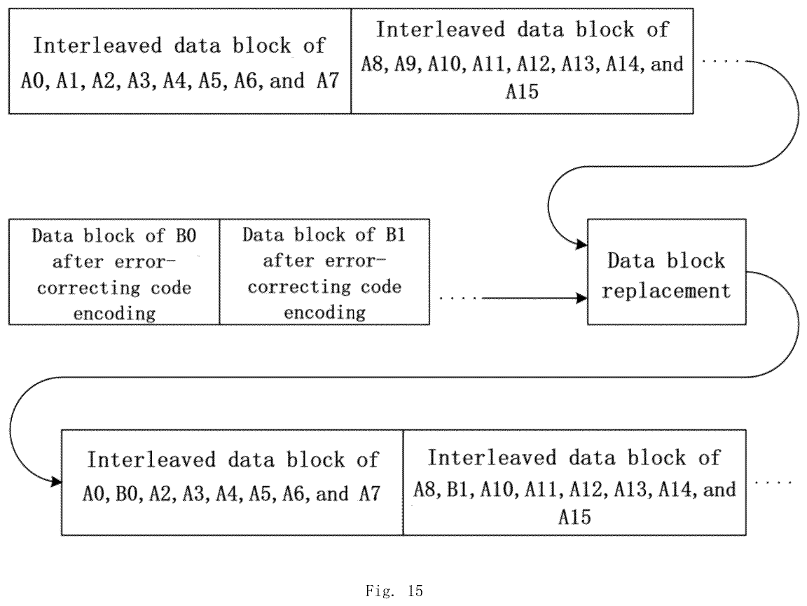

The second transmission terminal can replace multiple data blocks. As shown in FIG. 15, the data decoded by the line codes is the interleaved data blocks of 8 data blocks A0, A1, A2, A3, A4, A5, A6, A7. The second transmission terminal replaces the data block A1 with the data block B0 by using the method shown in FIG. 14. Then, the data decoded by the line codes is the interleaved data blocks of 8 data blocks A8, A9, A10, A11, A12, A13, A14, A15. The second transmission terminal replaces the data block A9 with the data block B1 by using the method shown in FIG. 14. In this embodiment, the data blocks A0, A1, . . . A15 and B0, B1 are data blocks encoded by the error-correcting codes.

A group of preset data blocks can form one logical transmission channel. For example, in the embodiment shown in FIG. 15, A1, A9, A17, . . . A₈ₙ₊₁(n≥0) can form a logical transmission channel. Different groups of preset data blocks can form different logical transmission channels. The transmission terminals can meet different transmission requirements through the logical transmission channels. The above-mentioned data block replacement method can be used for low-delay replacement of data blocks on the specified logical transmission channels, thereby supporting different transmission requirements between the transmission terminals.

The above-mentioned content is only the preferred implementation mode of the present invention, but the protection scope of the present invention is not limited to this. Any person skilled in the technical field can easily think of changes or replacements within the technical scope disclosed by the present invention, which should be covered within the protection scope of the present invention.

What is claimed is:

1. A physical layer data encoding, decoding, and transmission system, which comprising a first transmission terminal, a second transmission terminal, and a transmission channel; The first transmission terminal sends data to the second transmission terminal through the transmission channel,
which is characterized in that:
the first transmission terminal comprises an error-correcting code encoder, an interleaver, a line code encoder, and a transmitter;
the second transmission terminal comprises a receiver, a line code decoder, a deinterleaver, and an error-correcting code decoder;
the error-correcting code encoder encodes data with error-correcting codes;
the interleaver interleaves the data encoded by the error-correcting codes at a granularity of bit, with an interleaving depth of n;
the line code encoder encodes the interleaved data with line codes, and the line code encoding is performed in groups of m-bit binary numbers;
the transmitter sends the data encoded by the line codes to the transmission channel, and the data is transmitted to the second transmission terminal through the transmission channel;
the receiver receives the data sent through the transmission channel;
the line code decoder decodes the received data with line codes, and the data after line code decoding is in groups of m-bit binary numbers;
the deinterleaver deinterleaves the data decoded by the line codes at a granularity of 1 bit, with a deinterleaving depth of n;
the error-correcting code decoder decodes the deinterleaved data with error-correcting codes;
both n and m are fixed positive integers, and n≥m.

2. The physical layer data encoding, decoding, and transmission system according to claim 1, characterized in that:
the line code is a DC-balanced code.

3. The physical layer data encoding, decoding, and transmission system according to claim 1, characterized in that:
n≥2 m.

4. The physical layer data encoding, decoding, and transmission system according to claim 1, characterized in that:
the error-correcting code is a block code.

5. The physical layer data encoding, decoding, and transmission system according to claim 4, characterized in that:
each group of the block codes can correct at most one bit of error.

6. The physical layer data encoding, decoding, and transmission system according to claim 1, characterized in that:
the error-correcting code is an RS code, an ECC code, or a BCH code.

7. A physical layer data encoding method, characterized in that:
data is encoded with error-correcting codes;
the data encoded by the error-correcting codes is interleaved at a granularity of 1 bit, with an interleaving depth of n;
the interleaved data is encoded with line codes, and the line code encoding is performed in groups of m-bit binary numbers;
both n and m are fixed positive integers, and n≥m.

8. The physical layer data encoding method according to claim 7, characterized in that:
the line code is a DC-balanced code.

9. The physical layer data encoding method according to claim 7, characterized in that:
n≥2 m.

10. The physical layer data encoding method according to claim 7, characterized in that:
the error-correcting code is a block code.

11. The physical layer data encoding method according to claim 10, characterized in that:
each group of the block codes can correct at most one bit of error.

12. The physical layer data encoding method according to claim 7, characterized in that:
the error-correcting code is an RS code, an ECC code, or a BCH code.

13. A physical layer data decoding method, characterized in that:
received data is decoded with line codes, and the data after line code decoding is in groups of m-bit binary numbers;
the data decoded by the line codes is deinterleaved at a granularity of 1 bit, with a deinterleaving depth of n;
the deinterleaved data is decoded with error-correcting codes;
both n and m are fixed positive integers, and n≥m.

14. The physical layer data decoding method according to claim 13, characterized in that:
the line code is a DC-balanced code.

15. The physical layer data decoding method according to claim 13, characterized in that:
n≥2 m.

16. The physical layer data decoding method according to claim 13, characterized in that:
the error-correcting code is a block code.

17. The physical layer data decoding method according to claim 16, characterized in that:
each group of the block codes can correct at most one bit of error.

18. The physical layer data decoding method according to claim 13, characterized in that:
the error-correcting code is an RS code, an ECC code, or a BCH code.

19. A physical layer data replacement method for transmitting data blocks through a transmission system; the transmission system comprises a first transmission terminal, a second transmission terminal, and a transmission channel, and the first transmission terminal is connected to the second transmission terminal through the transmission channel,
characterized in that:
the first transmission terminal encodes the data blocks with error-correcting codes to generate data blocks encoded by the error-correcting codes, interleaves the encoded data blocks at a granularity of 1 bit with an interleaving depth of n, then encodes the interleaved data with line codes in groups of m-bit binary numbers, and finally sends the symbols generated after line code encoding to the transmission channel;
the second transmission terminal receives and decodes the symbols encoded by the line codes sent through the transmission channel, replaces the data at the preset replacement positions in the data decoded by the line codes, and re-encodes the replaced data with line codes;
both n and m are fixed positive integers, and n≥m.

20. The physical layer data replacement method according to claim 19, characterized in that:
the line code is a DC-balanced code.

21. The physical layer data replacement method according to claim 19, characterized in that:
n≥2 m.

22. The physical layer data replacement method according to claim 19, characterized in that:
the error-correcting code is a block code.

23. The physical layer data replacement method according to claim 22, characterized in that:
each group of the block codes can correct at most one bit of error.

24. The physical layer data replacement method according to claim 19, characterized in that:
the error-correcting code is an RS code, an ECC code, or a BCH code.
